(19) United States
(12) Patent Application Publication
(10) Pub. No.: US 2023/0216824 A1
(43) Pub. Date: Jul. 6, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Yoshifumi KANEKO, Kanagawa (JP)

(73) Assignee: FUJIFILM Business Innovation Corp., Tokyo (JP)

(21) Appl. No.: 17/884,323

(22) Filed: Aug. 9, 2022

(30) Foreign Application Priority Data
Jan. 4, 2022 (JP) 2022-000168

(51) Int. Cl. H04L 51/48; H04L 51/04; H04L 51/08

(52) U.S. Cl. CPC H04L 51/48; H04L 51/04; H04L 51/08

(57) ABSTRACT

An information processing apparatus includes a processor configured to: extract, upon receiving instructions from one of conversation members for transmission of an attached document in a middle of a conversation conducted using a messenger application, an attribute value of a predetermined attribute related to the attached document from the attached document; and inquire of, upon mismatch between an attribute value of the predetermined attribute extracted from a history of the conversation and the attribute value of the predetermined attribute extracted from the attached document, the one conversation member whether the attached document is to be transmitted.

### CROSS-REFERENCE TO RELATED APPLICATIONS

This application is based on and claims priority under 35 USC 119 from Japanese Patent Application No. 2022-000168 filed Jan. 4, 2022.

### BACKGROUND

### (i) Technical Field

The present disclosure relates to an information processing apparatus, a non-transitory computer readable medium storing a program, and an information processing method.

### (ii) Related Art

In recent years, increasingly more companies are adopting business chat as a communication tool to replace email. The business chat provides a messaging function to exchange messages in a chat room, and the messaging function has a function to transmit an attached document in the same manner as in email. However, a problem of erroneous transmission arises even in the business chat as in the email.

For example, Japanese Unexamined Patent Application Publication No. 2019-091384 proposes a system to prevent transmission of an attached document to a wrong thread or a wrong group by displaying the name of a correct thread or a correct group at upper and lower portions within 2 cm of an input screen and a confirmation screen.

In addition, Japanese Unexamined Patent Application Publication No. 2017-134516 proposes a system that, upon detection of work performed in another window during generation of message information with an information-sharing tool, displays a confirmation screen for the content of transmission.

Other examples of the related art include Japanese Unexamined Patent Application Publication Nos. 2006-227810 and 2006-259843.

### SUMMARY

However, as in Japanese Unexamined Patent Application Publication Nos. 2019-091384 and 2017-134516, if an attempt is made to always display a warning message upon each detection of an operation potentially causing erroneous transmission, such display may result in substantially no effect on the warning. In addition, the necessity of confirmation each time may increase the time and effort of users and reduce the work efficiency.

Meanwhile, when an attached document is transmitted using a messenger application on a computer system, before the attached document is transmitted, information related to the attached document may be exchanged in a conversation, or some instructions may be given or a schedule may be delivered in advance for transmission of the attached document.

Aspects of non-limiting embodiments of the present disclosure relate to preventing erroneous transmission of an attached document more reliably, as compared to when a history of conversation utilizing a messenger application is not referred to.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: extract, upon receiving instructions from one of conversation members for transmission of an attached document in a middle of a conversation conducted using a messenger application, an attribute value of a predetermined attribute related to the attached document from the attached document; and inquire of, upon mismatch between an attribute value of the predetermined attribute extracted from a history of the conversation and the attribute value of the predetermined attribute extracted from the attached document, the one conversation member whether the attached document is to be transmitted.

### BRIEF DESCRIPTION OF THE DRAWINGS

Exemplary embodiment of the present disclosure will be described in detail based on the following figures, wherein:

FIG. 1 is a diagram illustrating an example of a configuration of a communication system according to an exemplary embodiment;

FIG. 2 is a chart illustrating an example of a data structure of document type information stored in a document type information storage in the exemplary embodiment;

FIG. 3 is a chart illustrating an example of a data structure of attribute information stored in an attribute information storage in the exemplary embodiment;

FIG. 4 is a flowchart illustrating the processing when chat is used in the exemplary embodiment;

FIG. 5 is a flowchart illustrating attached document transmission processing illustrated in FIG. 4;

FIG. 6 is a chart illustrating part of information on the history of conversation made between users A, B in the exemplary embodiment;

FIG. 7 is a chart illustrating another part of information on the history of conversation made between users A, B in the exemplary embodiment; and

FIG. 8 is a chart illustrating another part of information on the history of conversation made between users A, B in the exemplary embodiment.

### DETAILED DESCRIPTION

Hereinafter an exemplary embodiment of the present disclosure will be described with reference to the drawings.

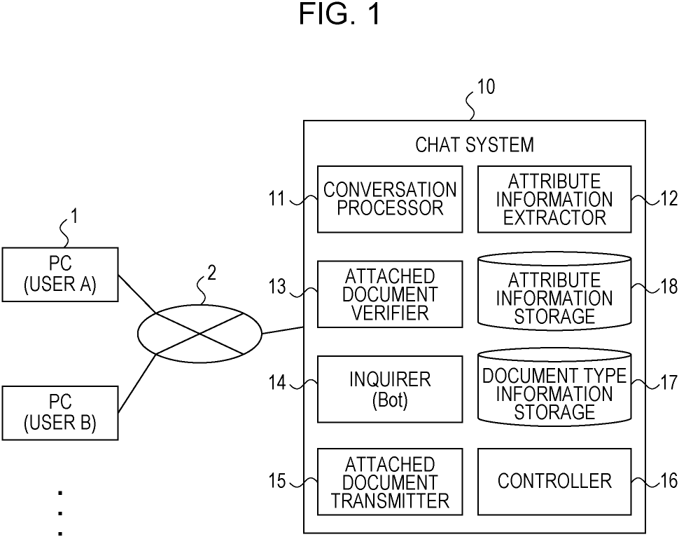

FIG. 1 is a diagram illustrating an example of a configuration of a communication system according to the exemplary embodiment. FIG. 1 illustrates a system configuration in which a personal computer (hereinafter a “PC”) 1 and a chat system 10 are coupled via a network 2 such as the Internet.

The “chat” is defined as a mechanism that allows real-time conversation via the Internet, for example, and the chat system 10 provides a chat service to users who use a computer (the above-mentioned “PC 1”) in which a chat application implementing chat is installed.

Here, “messenger application” is a collective term for applications that provide message exchange by interaction with text messages or free IP telephone, in short, a messaging function. In the exemplary embodiment, a messaging function, and in addition a file attachment function for transmitting a document are provided to users by utilizing the chat as the messenger application. Like this, a case where chat is used for communication between users is described as an example in the exemplary embodiment. However, another messenger application that provides a messaging function and a file attachment function may be utilized.

The PC 1 is an information processing apparatus to be used by a user to perform chat. Thus, a chat application is installed in the PC 1. The PC 1 can be implemented by a general-purpose hardware configuration which has been existing from the past. Specifically, the PC 1 is configured to include a user interface including a storage such as a CPU, a ROM, a RAM, a hard disk drive (HDD), a network interface served as a communication unit, an input unit such as a mouse and a keyboard, and a display unit such as a display.

As described above, the chat system 10 provides a chat service to the users of the PC 1. The chat system 10 is an example of an information processing apparatus according to the present disclosure, and can be implemented by a configuration of a general-purpose hardware, such as a server computer, which has been existing from the past. Specifically, the chat system 10 is configured to include at least a storage such as a CPU, a ROM, a RAM, a hard disk drive (HDD), and a network interface served as a communication unit.

The chat system 10 has a conversation processor 11, an attribute information extractor 12, an attached document verifier 13, an inquirer 14, an attached document transmitter 15, a controller 16, a document type information storage 17 and an attribute information storage 18. Note that the components not used for describing the exemplary embodiment are omitted from the drawings.

The conversation processor 11 performs message exchange, that is, processing related to a conversation, the message exchange being made by a user posting a message on a chat room. The attribute information extractor 12 interprets the content of a message by performing natural language processing. If the attribute value of a predetermined attribute is included in the message, the attribute information extractor 12 extracts the attribute value of the predetermined attribute from the message, and stores the attribute value in the attribute information storage 18 as attribute information. In order to transmit an attached document, it is necessary to specify an addressee and attach a document to be transmitted to the addressee at least. Thus, attribute items corresponding to predetermined attributes are an addressee, and attribute information related to the attached document. The attribute information related to the attached document is information by which the attached document is identifiable, and the information is obtained by analyzing the attached document by the attached document verifier 13. In the exemplary embodiment, a description is given using an example of type of document and format (hereinafter referred to as a “form”) of document as the information by which an attached document is identifiable.

The attached document verifier 13 extracts the attribute values of predetermined attributes by analyzing an actually attached document as the attached document, and checks the attribute values of the predetermined attributes extracted from the attached document with the attribute information extracted by the attribute information extractor 12, thereby determining whether the attribute values match the attribute information. The predetermined attributes extracted by the attached document verifier 13 are the same as the predetermined attributes extracted by the attribute information extractor 12. In other words, the attribute information extractor 12 extracts, from a history of conversation, predetermined attributes extractable from actual attached documents by the attached document verifier 13, in other words, attribute items such as an addressee.

When the attribute values to be compared do not match, it can be determined that there is a possibility of erroneous transmission, thus the inquirer 14 inquires of an attached document transmission source user for confirmation to see if there is a possibility of a wrong addressee or a wrongly attached document. In the exemplary embodiment, the inquirer 14 is implemented by a chatbot. When the attached document is confirmed to be erroneously prepared for transmission, the attached document transmitter 15 transmits the attached document to the addressee. The controller 16 performs control of conversation in the chat system 10, specifically, control of transmission of attached documents conducted during a conversation by working in coordination with the above-described components 11 to 15.

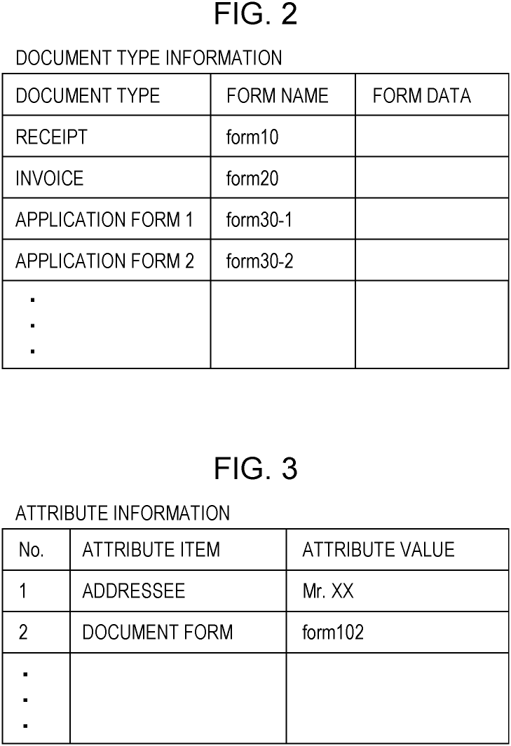

FIG. 2 is a chart illustrating an example of a data structure of document type information stored in the document type information storage 17 in the exemplary embodiment. The document type information is prepared in advance. The document type information is configured such that for each type of document, a form name used in a document of the type, and form data which identifies the layout of the document type are associated with each other.

FIG. 3 is a chart illustrating an example of a data structure of attribute information stored in the attribute information storage 18 in the exemplary embodiment. As described above, the attribute information is related to an attached document extracted by the attribute information extractor 12. The attribute information is configured such that an attribute item that specifies the attribute is associated with an attribute value of the attribute item extracted by the attribute information extractor 12. In the exemplary embodiment, an addressee and a file form that represents a type of form of attached document are exemplified as the attribute information extracted from information on the history of conversation. However, the type of attribute item is not limited to this.

The components 11 to 16 in the chat system 10 are each implemented by a coordinated operation of a computer that forms the chat system 10 and a program executed by a CPU installed in the computer. The storages 17, 18 are each implemented by an HDD installed in the chat system 10. Alternatively, a RAM or an external storage unit may be utilized through a network.

In addition, the programs used in the exemplary embodiment may be provided not only by a communication unit, but also in a form recorded in a computer-readable recording medium such as a CD-ROM and a USB memory. The programs provided by a communication unit and a recording medium are installed in a computer, and the CPU of the computer executes the programs sequentially, thereby implementing various processes.

Next, the operation in the exemplary embodiment will be described.

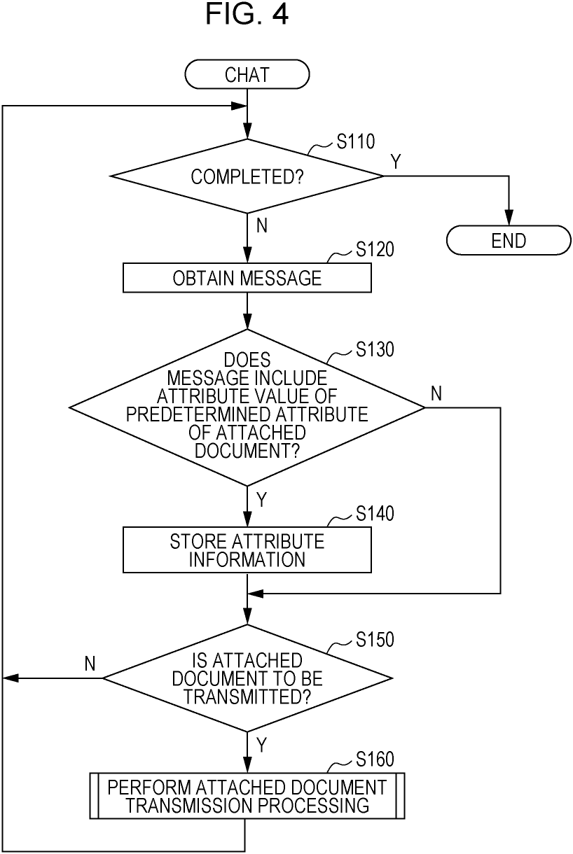

In the exemplary embodiment, a description will be given under the assumption that user A and user B who utilize the PC 1 each start a chat, and have a conversation as a conversation member. Hereinafter, the processing in the chat system 10 when chat is used will be described with reference to the flowchart illustrated in FIG. 4.

After the users A, B start a chat to make a conversation, they continue the conversation by posting a message with the function provided by the conversation processor 11 until the conversation is completed (N in step 110). While the conversation is not completed (Y in step 110), when the conversation processor 11 obtains a message posted by one of the users A, B in the middle of the conversation between the user A and the user B (step 120), the attribute information extractor 12 performs natural language processing to interpret the content of the message obtained by the conversation processor 11, and determines whether the attached document includes the attribute value of one of the above-described predetermined attributes. When it is determined that the attached document does not include the attribute value of any predetermined attribute (N in step 130), the flow proceeds to step 150.

When it is determined that the attached document includes the attribute value of a predetermined attribute (Y in step 130), as illustrated in FIG. 3, the attribute information extractor 12 associates the attribute value of the predetermined attribute extracted from the message with an attribute item, and stores the attribute value in the attribute information storage 18 as attribute information (step 140).

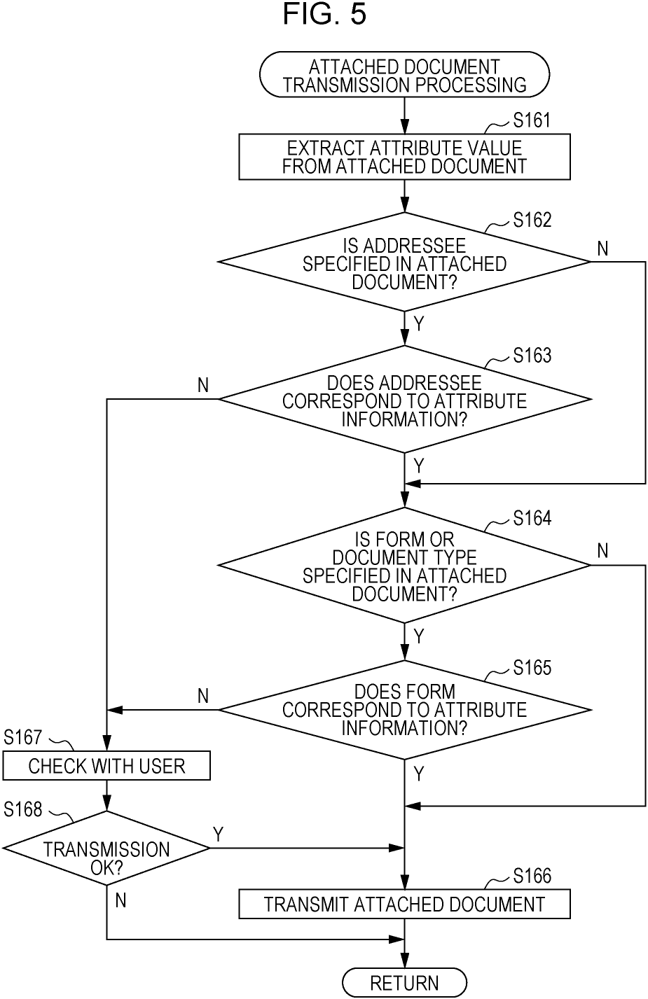

Subsequently, when the message does not include instructions to transmit an attached document (N in step 150), the flow returns to step 110 to process the next posted message. In contrast, when the message includes instructions to transmit an attached document (Y in step 150), the attached document transmission processing described below is performed (step 160). Hereinafter, the attached document transmission processing in the exemplary embodiment will be described with reference to the flowchart illustrated in FIG. 5. Note that a description is given assuming that a document to be transmitted is properly attached. In case of omission of attachment, an error message is displayed to cope with the omission in the same manner as before.

The attached document verifier 13 analyzes a document attached to the message by performing natural language processing to extract the attribute value of a predetermined attribute related to the attached document (step 161). The attached document to be analyzed is desirably analyzed for not only the content of the attached document, but also for information related to transmission of the attached document, such as a document name and transmission date/time. As an extraction target, the attached document verifier 13 only have to process the attribute item of the attribute value stored in the attribute information storage 18 in step 140. For example, when an addressee is not extracted from the history of conversation, as described in the following processing, an addressee does not need to be extracted from the attached document in step 161 because there is no addressee as a comparison target.

When no addressee is specified in the attached document as a result of analysis (N in step 162), even if an addressee is stored in the attribute information storage 18, an addressee as a comparison target is not extractable from the attached document. Thus, the flow proceeds to step 164. In contrast, when an addressee is specified in the attached document as a result of analysis (Y in step 162), the attached document verifier 13 compares the addressee extracted from the attached document with each addressee stored in the attribute information storage 18. When the addressees do not match (N in step 163), the flow proceeds to step 167.

In contrast, when the addressees match (Y in step 163), the attached document verifier 13 determines that the addressee identified by the attached document is properly specified as far as based on the history of conversation. In this case, the attached document verifier 13 analyzes whether a form of attached document or a type of document has been specified. When no form or no type of document is specified as a result of the analysis (N in step 164), even if a form or a type of document is stored in the attribute information storage 18, a form or a type of document as a comparison target is not extractable from the attached document. Thus, the flow proceeds to step 166. In contrast, when a form or a type of document is specified in the attached document (Y in step 164), if a type of document is specified, the attached document verifier 13 refers to the document type information with the type of document identified from the attached document, thereby identifying the form of the document type. The attached document verifier 13 then compares the form identifiable from the attached document with the file forms stored in the attribute information storage 18. When the forms do not match (N in step 165), the flow proceeds to step 167.

In contrast, when the forms match (Y in step 165), the attached document verifier 13 determines the form identifiable from the attached document is correct as far as based on the history of conversation. In this case, it is determined that a proper document is attached by a user, and the attached document transmitter 15 transmits the attached document to the specified addressee (step 166).

When the addressee or the form of attached document identified from the attached document does not match the attribute value corresponding to the attribute item stored in the step 140 (N in step 163, N in step 165), the attribute value of the predetermined attribute extracted from the document actually attached does not match the attribute value extracted from the history of conversation, thus it is not possible to verify that the actually attached document is a proper attached document. In other words, when it is determined that transmission of the attached document as it is may cause erroneous transmission, the inquirer 14 confirms the validity of the attached document, in other words, the appropriateness of transmission of the attached document by checking with the user (step 167). The confirmation with the user will be described using a specific example.

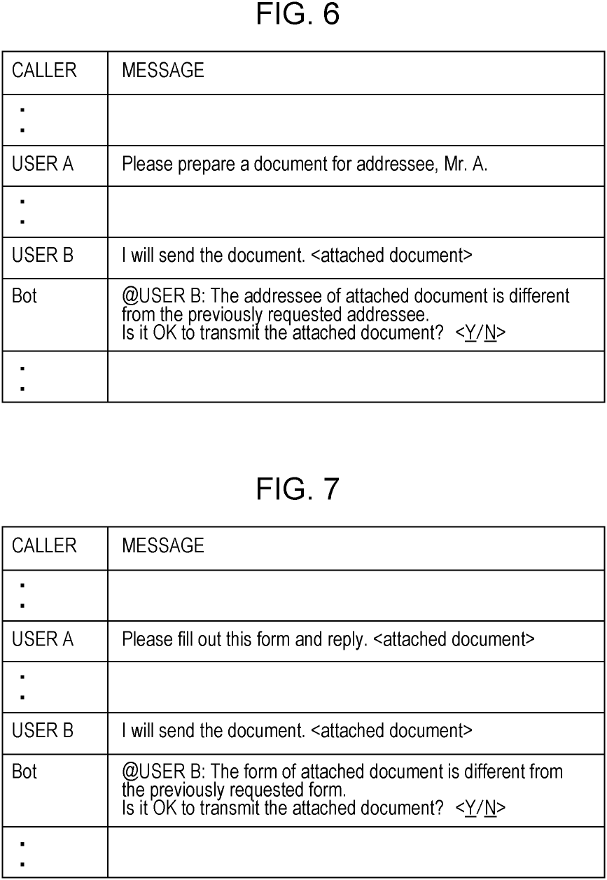

FIGS. 6 to 8 are each a chart illustrating part of information on the history of conversation made between the users A, B. In FIGS. 6 to 8, an utterer in a conversation is associated with the content of utterance by the utterer. Note that Bot means a message posted by the inquirer 14.

First, in the example of conversation illustrated in FIG. 6, the user A instructs the user B to prepare a file addressed to the user A. Thus, the addressee of the attached document can be identified as the “user A” from the history of conversation. The user B prepares a file in response to a request from the user A, and utilizes the chat to post a message to transmit the prepared file, that is, a document to the user A. When a document is attached to the message from the user B, as described above, the attached document verifier 13 analyzes the document attached by the user B. When the addressee is recognized as a user other than the “user A” as a result of the analysis of the content of the attached document, there is a possibility of a wrong addressee, that is, there is a possibility of erroneous transmission, thus as illustrated in FIG. 6, the inquirer 14 (Bot) inquires of the document transmission source user B whether the attached document is to be transmitted. In response to a confirmation message from the Bot, the user B confirms the attached document, and replies to the inquiry by selecting “Y” or “N” of the links included in the confirmation message. When the attached document is transmitted as it is, the user B selects “Y”, and when transmission of the document is suspended due to attachment of a wrong document, the user B selects “N”.

Next, according to the example of conversation illustrated in FIG. 7, the user A sends a file to be filled out to the user B as an attached document. Thus, the form of an attached document can be identified by the attached document from the history of conversation. For example, when the user A attaches the form of application form 1, the form can be identified as “form 30-1” by referring to the document type information. In response to a request from the user A, the user B prepares a file by filling out the form “form 30-1” with necessary information, and utilizes the chat to post a message to transmit the prepared file, that is, a document to the user A. When a document is attached to the message from the user B, as described above, the attached document verifier 13 analyzes the document attached by the user B. When the form is recognized as a form other than the “form 30-1” as a result of the analysis of the content of the attached document, there is a possibility of a wrong attached document, that is there is a possibility of erroneous transmission, thus as illustrated in FIG. 7, the inquirer 14 (Bot) inquires of the document transmission source user B whether the attached document is to be transmitted. As described with reference to FIG. 6, the user B selects “Y” or “N”.

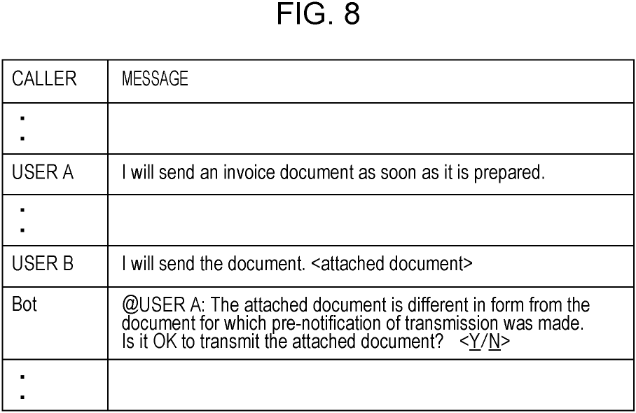

Next, according to the example of conversation illustrated in FIG. 8, the user A informs the user B that the user A will send an invoice file when it is prepared. Specifically, the type of an attached document transmitted subsequently can be identified from the history of conversation based on the content of conversation. For example, when the user A transmits an invoice, the form can be identified as “form 20” by referring to the document type information. Subsequently, as informed to the user B in a message, the user A prepares an invoice, and utilizes the chat to post a message to transmit the invoice file, that is, a document to the user B. When a document is attached to the message from the user A, as described above, the attached document verifier 13 analyzes the document attached by the user A. When the form is recognized as a form other than the “form 20” as a result of the analysis of the content of the attached document, there is a possibility of a wrong attached document, that is, there is a possibility of erroneous transmission, thus as illustrated in FIG. 8, the inquirer 14 (Bot) inquires of the document transmission source user A whether the attached document is to be transmitted. As described with reference to FIG. 6, the user A selects “Y” or “N”.

Returning to FIG. 5, when a user selects “Y” from a confirmation message, it is determined that an attached document may be transmitted as it is (Y in step 168), and the attached document transmitter 15 transmits the attached document to a specified addressee (step 166). In contrast, when a user selects “N” from the confirmation message, it is determined that instructions to suspend transmission of the attached document are given (N in step 168), and the chat system 10 completes the attached document transmission processing.

Returning to FIG. 4, as described above, when the attached document transmission processing (step 160) is completed, the flow proceeds to step 110.

In the exemplary embodiment, as described above, the attribute value of a predetermined attribute identifiable from the history of conversation is extracted, and when the attribute value of the attribute extractable from an attached document actually attached does not match the attribute value of the attribute extracted from the history of conversation, it is determined that there is a possibility of erroneous transmission of the attached document, and inquiries are made of the transmission source user before the attached document is transmitted. Therefore, erroneous transmission of an attached document can be prevented more reliably.

In the description above, a case where an addressee or a document form is used as a predetermined attribute has been described as an example; However, erroneous transmission may be determined using a face image, for example. Specifically, determination processing is performed as follows.

First, as the image data to identify each of users who use the chat, a face image of each user is registered in the chat system 10 in advance. The registration may be made when a chat application is installed or at a later time after the installation. Here, it is assumed that when the user A transmits an attached document to the user B, a file to be transmitted includes images of individuals. The attached document verifier 13 extracts face images by analyzing the images of individuals in the attached document. In addition, the attached document verifier 13 obtains, from a storage unit (not illustrated) at a registration site, the face images of the transmission source user and the transmission destination user registered in advance, in short, the face images of the users A, B. The attached document verifier 13 then checks the face images extracted from the attached document with the obtained face images of the users A, B. As a result of the checking, the attached document verifier 13 determines whether the face images of the users A, B having a conversation are included in the face images of users contained in the attached document.

When a face image matching any of the user A and the user B having a conversation is not included in the face images of users extracted from the attached document, the attached document verifier 13 determines that there is a possibility of erroneous transmission of the attached document.

It is assumed that when the user A transmits a photograph file to the user B, and images of individuals are contained in the photograph, both the transmission source user and the transmission destination user are often in the photograph. However, the determination illustrated here as to whether there is a possibility of erroneous transmission is just an example, and the exemplary embodiment is not limited to this. For example, when one of the transmission source user and the transmission destination user appears in the photograph, inquiries may not be made of the transmission source user whether the attached document is to be transmitted. Otherwise, that is, when the attached document includes a photograph in which neither of the user A nor the user B appears, it is determined that there is a possibility of erroneous transmission, and inquiries are made of the transmission source user.

When the history of conversation between the users A, B has a post of a message indicating that a photograph with both the two users A, B shown is provided, for a photograph in which both the users A, B do not appear, it can be determined that there is a possibility of erroneous transmission. In addition, when the history of conversation has a message indicating that a photograph will be presented, in which a user (for example, user C) other than the transmission source user and the transmission destination user appears, for an attached document including the face image of the user C registered in advance, it can be determined that there is no possibility of erroneous transmission.

In the exemplary embodiment, when an attribute value corresponding to the same attribute item as a predetermined attribute (that is, an attribute item) corresponding to an attribute value extractable from the history of conversation can be extracted from an attached document actually attached, both attribute values are compared, and if the attribute values do not match, it is determined that there is a possibility of erroneous transmission, and inquiries are made of the transmission source user for confirmation. It is not always the case that a message is posted in a conversation, and a description is given in an attached document for all the attribute items related to the attached document. Therefore, a case can be easily assumed where an attribute value corresponding to the same attribute item is not extractable from one of the history of conversation and the attached document. Thus, in the exemplary embodiment, as described above, in consideration of the time and effort required for confirmation by the transmission source user, inquiries are not made of the transmission source user whether the attached document is to be transmitted. Naturally, in order to prevent erroneous transmission of an attached document more reliably, inquiries may be made of the transmission source user.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
extract, upon receiving instructions from one of conversation members for transmission of an attached document in a middle of a conversation conducted using a messenger application, an attribute value of a predetermined attribute related to the attached document from the attached document; and
inquire of, upon mismatch between an attribute value of the predetermined attribute extracted from a history of the conversation and the attribute value of the predetermined attribute extracted from the attached document, the one conversation member whether the attached document is to be transmitted.

2. The information processing apparatus according to claim 1,
wherein the predetermined attribute is information by which a document to be transmitted is identifiable.

3. The information processing apparatus according to claim 2,
wherein the information by which a document to be transmitted is identifiable is a form of the document.

4. The information processing apparatus according to claim 2,
wherein the information by which a document to be transmitted is identifiable is a type of the document.

5. The information processing apparatus according to claim 1,
wherein the predetermined attribute is an addressee of the attached document.

6. The information processing apparatus according to claim 1,
wherein the processor is configured to inquire of, upon a determination that an attached document for which instructions for transmission are given includes an image of one or more individuals, and any of users participating in the conversation is not included in the one or more individuals identified from the image, the one conversation member whether the attached document is to be transmitted.

7. The information processing apparatus according to claim 6,
wherein the processor is configured to:
upon a determination that an attached document for which instructions for transmission are given includes an image of one or more individuals, obtain image data of users participating in the conversation; and
determine whether an image of the users participating in the conversation is included in the attached document for which instructions for transmission are given, by checking the image of one or more individuals included in the attached document with the image data.

8. The information processing apparatus according to claim 1,
wherein the processor is configured to not inquire of, upon a determination that an attribute value of the predetermined attribute is not extractable from a history of the conversation, the one conversation member whether the attached document is to be transmitted.

9. A non-transitory computer readable medium storing a program causing a computer to implement a process comprising:
extracting, upon receiving instructions by one of conversation members for transmission of an attached document in a middle of a conversation conducted using a messenger application, an attribute value of a predetermined attribute related to the attached document from the attached document; and
inquiring of, upon mismatch between an attribute value of the predetermined attribute extracted from a history of the conversation and the attribute value of the predetermined attribute extracted from the attached document, the one conversation member whether the attached document is to be transmitted.

10. An information processing method comprising:
extracting, upon receiving instructions by one of conversation members for transmission of an attached document in a middle of a conversation conducted using a messenger application, an attribute value of a predetermined attribute related to the attached document from the attached document; and
inquiring of, upon mismatch between an attribute value of the predetermined attribute extracted from a history of the conversation and the attribute value of the predetermined attribute extracted from the attached document, the one conversation member whether the attached document is to be transmitted.
